(19) United States
(12) Patent Application Publication
(10) Pub. No.: US 2023/0366694 A1
(43) Pub. Date: Nov. 16, 2023

(54) INFORMATION PROCESSING METHOD, INFORMATION PROCESSING DEVICE, NON-TRANSITORY COMPUTER-READABLE RECORDING MEDIUM, AND DISPLAY DEVICE

(71) Applicant: Panasonic Intellectual Property Corporation of America, Torrance, CA (US)

(72) Inventors: Atsuyoshi KITA, Osaka (JP); Tetsuji FUCHIKAMI, Osaka (JP); Tatsumi NAGASHIMA, Osaka (JP)

(73) Assignee: Panasonic Intellectual Property Corporation of America, Torrance, CA (US)

(21) Appl. No.: 18/227,008

(22) Filed: Jul. 27, 2023

Related U.S. Application Data
(63) Continuation of application No. PCT/JP2022/000945, filed on Jan. 13, 2022.

(30) Foreign Application Priority Data
Feb. 1, 2021 (JP) 2021-014476

(51) Int. Cl. G01C 21/36; G01C 21/34; G01C 21/00

(52) U.S. Cl. CPC G01C 21/367; G01C 21/3469; G01C 21/3881

(57) ABSTRACT

An information processing device includes an acquisition unit that acquires a plurality of requests, and a parallel processing unit that executes, in parallel, a plurality of pieces of response processing corresponding to a plurality of acquired requests. In each piece of the response processing, planimetric feature information corresponding to a tile ID included in a request is extracted from a planimetric feature database, a geographic feature amount between a current position and a planimetric feature indicated by the extracted planimetric feature information is calculated based on the extracted planimetric feature information, reachability by a vehicle to the planimetric feature is determined based on the calculated geographic feature amount and remaining energy information, and the determined reachability and the extracted planimetric feature information are output to a display device.

### TECHNICAL FIELD

The present disclosure relates to a technique for displaying reachability by a vehicle.

### BACKGROUND ART

Patent Literature 1 discloses a technique of calculating a travelable distance of a vehicle by evaluating a plurality of links extending outward from a position of the vehicle, and displaying a travelable range of the vehicle on a map screen based on a calculation result.

However, in Patent Literature 1, since a travelable distance of an entire map image displayed on a display device is calculated at a time, there has been a problem that response time from issuance of a request to display of a travelable range on the display device is prolonged.

### CITATION LIST

### Patent Literature

Patent Literature 1: JP 6384876 B2

### SUMMARY OF INVENTION

The present disclosure has been made in view of the above problem, and provides a technique capable of shortening response time taken to display reachability.

An information processing method according to an aspect of the present disclosure is an information processing method in an information processing device that controls a display device that displays a map image divided into a plurality of tiles according to a zoom level, each tile being assigned with a tile ID. The information processing method includes acquiring a plurality of requests corresponding to each of a plurality of tiles displayed on the display device, each of the requests including the tile ID, a current position of a vehicle, and remaining energy information of the vehicle, and executing, in parallel, a plurality of pieces of response processing corresponding to the plurality of requests that are acquired, and, in each piece of the response processing, extracting planimetric feature information indicating a planimetric feature to be displayed on each tile, the planimetric feature information corresponding to the tile ID included in a request, from a planimetric feature database in which the tile ID and the planimetric feature information are associated with each other, calculating, based on the planimetric feature information that is extracted, a geographic feature amount between the current position and a feature indicated by the planimetric feature information that is extracted, determining reachability by the vehicle to the planimetric feature based on the geographic feature amount that is calculated and the remaining energy information, and outputting the reachability that is determined and the planimetric feature information that is extracted to the display device.

According to the present disclosure, it is possible to shorten response time to a request for displaying a travelable range.

### BRIEF DESCRIPTION OF DRAWINGS

FIG. 1 is a diagram illustrating an example of an entire configuration of an information processing system according to an embodiment of the present disclosure.

FIG. 2 is a block diagram illustrating an example of a configuration of a display device illustrated in FIG. 1.

FIG. 3 is a block diagram illustrating an example of a configuration of an information processing device illustrated in FIG. 1.

FIG. 4 is a diagram illustrating an example of a configuration of a vehicle illustrated in FIG. 1.

FIG. 5 is a diagram illustrating an example of a data configuration of a planimetric feature database.

FIG. 6 is a diagram illustrating an example of a data configuration of a geographic feature amount database.

FIG. 7 is a graph illustrating a connection relationship of nodes stored in the geographic feature amount database illustrated in FIG. 6.

FIG. 8 is a diagram illustrating a calculation example of a geographic feature amount from a node “1” to a node “10” in the geographic feature amount database illustrated in FIG. 6.

FIG. 9 is a flowchart illustrating an example of processing of the display device in the embodiment of the present disclosure.

FIG. 10 is a flowchart illustrating an example of processing of the information processing device according to the embodiment of the present disclosure.

FIG. 11 is a flowchart illustrating details of response processing illustrated in FIG. 10.

FIG. 12 is a flowchart illustrating details of planimetric feature information extraction processing illustrated in FIG. 11.

FIG. 13 is an explanatory diagram of processing for extracting geometry data.

FIG. 14 is a diagram illustrating an example of a display screen of a superimposed map image displayed on a display unit.

FIG. 15 is a diagram illustrating an example of a data configuration of each of the geographic feature amount database in a comparative example of the present disclosure and the geographic feature amount database in a first modification.

FIG. 16 is a graph illustrating a connection relationship of nodes for each of the geographic feature amount database according to the comparative example illustrated in FIG. 15 and the geographic feature amount database according to the first modification.

FIG. 17 is a diagram illustrating an example of a data configuration of the planimetric feature database according to the first modification.

FIG. 18 is a diagram illustrating an example of a display screen in a ninth modification of the present disclosure.

FIG. 19 is a diagram illustrating an example of a display screen in a tenth modification of the present disclosure.

FIG. 20 is a diagram illustrating an example of a display screen in an eleventh modification of the present disclosure.

FIG. 21 is a diagram illustrating an example of a display screen in a twelfth modification of the present disclosure.

### DESCRIPTION OF EMBODIMENTS

(Knowledge Underlying Present Disclosure)

In recent years, electric vehicles have been widely used. Since an electric vehicle has a short cruising distance, it is required to display a travelable range from a current position on a map image. In related arts including Patent Literature 1, a travelable range of an entire map image displayed on a display device is calculated at a time. For this reason, there has been a problem that response time from when a request is issued for the display device to display a travelable range to when a travelable range is displayed on the display device is prolonged.

In particular, in a navigation system that is widely used in recent years and navigates a vehicle to a destination on a mobile terminal such as a smartphone, response time is further prolonged since the mobile terminal is connected to a cloud server that provides a navigation function via a network.

Meanwhile, in a map service on the Internet, a map image is divided into a plurality of tiles according to a zoom level, and drawing processing is performed in units of tiles. The zoom level is a numerical value that designates the number of divisions of one world map, and the number of divisions of the world map increases as the value increases. Each divided region is referred to as a tile.

In view of the above, the present inventor has found that response time can be shortened by dividing processing in units of tiles and executing the divided processing in parallel for calculation of a travelable range, and has arrived at aspects described below.

An information processing method according to an aspect of the present disclosure is an information processing method in an information processing device that controls a display device that displays a map image divided into a plurality of tiles according to a zoom level, each tile being assigned with a tile ID. The information processing method includes acquiring a plurality of requests corresponding to each of a plurality of tiles displayed on the display device, each of the requests including the tile ID, a current position of a vehicle, and remaining energy information of the vehicle, and executing, in parallel, a plurality of pieces of response processing corresponding to the plurality of requests that are acquired, and, in each piece of the response processing, extracting planimetric feature information indicating a planimetric feature to be displayed on each tile, the planimetric feature information corresponding to the tile ID included in a request, from a feature database in which the tile ID and the planimetric feature information are associated with each other, calculating, based on the planimetric feature information that is extracted, a geographic feature amount between the current position and a planimetric feature indicated by the planimetric feature information that is extracted, determining reachability by the vehicle to the planimetric feature based on the geographic feature amount that is calculated and the remaining energy information, and outputting the reachability that is determined and the planimetric feature information that is extracted to the display device.

According to the present configuration, a plurality of requests corresponding to each of a plurality of tiles displayed by the display device are acquired, and a plurality of pieces of response processing corresponding to a plurality of the acquired requests are executed in parallel. Then, in each piece of the response processing, a plurality of requests are acquired, planimetric feature information corresponding to the request is extracted from the planimetric feature database, a geographic feature amount between a current position of the vehicle and each planimetric feature is calculated, reachability to each planimetric feature is determined based on the geographic feature amount and remaining energy information of the vehicle, and the determined reachability and the extracted planimetric feature information are output to the display device.

For this reason, for example, when the number of tiles displayed on the display device is n, response time from issuance of a request to display of a reachable range on the display device is reduced to approximately 1/n as compared with a case where response processing is executed in series. As a result, response time required until reachability is displayed can be shortened.

Furthermore, in the present configuration, since a tile ID is included in a request and planimetric feature information corresponding to the tile ID included in the request is extracted from the planimetric feature database, planimetric feature information indicating a planimetric feature suitable for a zoom level can be quickly extracted.

Furthermore, in the present configuration, since reachability by the vehicle to each planimetric feature is determined based on the extracted planimetric feature information and the remaining energy information of the vehicle, it is possible to determine the reachability only for a planimetric feature suitable for a zoom level. As a result, the present configuration can shorten the response time as compared with a case of determining the reachability of all planimetric features included in a tile.

Furthermore, in the present configuration, since the extracted planimetric feature information and the determined reachability are output to the display device, the display device can display a planimetric feature suitable for a zoom level and the reachability to the planimetric feature. As a result, a planimetric feature not suitable for a zoom level and the reachability to the planimetric feature are prevented from being displayed, and the reachability can be displayed in an easily viewable manner.

The information processing method may further include storing the planimetric feature information extracted from the planimetric feature database in a cache memory in association with the tile ID, and, in extraction of the planimetric feature information, extracting the planimetric feature information from the cache memory in a case where the planimetric feature information corresponding to the tile ID included in the request is stored in the cache memory.

According to the present configuration, planimetric feature information extracted from the planimetric feature database is stored in the cache memory in association with the tile ID. For this reason, in a case where requests with the same tile ID are acquired after the above, planimetric feature information corresponding to the request can be quickly acquired.

In the information processing method, the planimetric feature information may include geometry data indicating a topography of the planimetric feature, and the information processing method may further include extracting the geometry data corresponding to the zoom level from among pieces of the geometry data included in the planimetric feature information extracted by the planimetric feature database, and, in output to the display device, outputting the geometry data that is extracted by including the geometry data that is extracted in the planimetric feature information.

According to the present configuration, the geometry data corresponding to the zoom level is extracted from the geometry data included in the planimetric feature information extracted from the planimetric feature database, and planimetric feature information including the extracted geometry data is output to the display device. For this reason, the display device can display a shape of a planimetric feature at granularity suitable for the zoom level.

Here, an aspect in which a tile ID and planimetric feature information are associated on a one-to-one basis, and geometry data extracted in advance according to a zoom level is stored in each planimetric feature information is also assumed. However, in this case, it is necessary to store a large number of pieces of planimetric feature information even for a planimetric feature on a tile that is rarely browsed, and a data amount of the planimetric feature database becomes excessive. In the present configuration, since processing of extracting the geometry data is employed, a data amount of the planimetric feature database can be reduced as compared with this aspect.

The information processing method may further include, in calculation of the geographic feature amount, calculating the geographic feature amount with reference to a geographic feature amount database that stores the geographic feature amount between itself and a predetermined reachable planimetric feature for each of a plurality of planimetric features.

In a case where a general path search method such as Dijkstra's algorithm is used, it is not possible to calculate a geographic feature amount for a tile that does not include the current position in the inside.

According to the present configuration, a geographic feature amount between the current position and each planimetric feature is calculated by referring to the geographic feature amount database that stores a geographic feature amount between itself and a predetermined reachable planimetric feature for each of a plurality of planimetric features. For this reason, even for a tile that does not include the current position, a geographic feature amount between the current position and a planimetric feature in the tile can be calculated.

In the information processing method, a plurality of the planimetric features for which the geographic feature amount is stored in the geographic feature amount database may be planimetric features allocated to each tile one by one at a maximum zoom level, and the planimetric feature information stored in the planimetric feature database may indicate a planimetric feature allocated to each tile one by one at the maximum zoom level.

Even if a plurality of planimetric features are included in one tile at the maximum zoom level, since a plurality of these planimetric features are close to each other, there is no significant difference in reachability, and there is no problem even if the planimetric features are aggregated in one node.

According to the present configuration, a plurality of planimetric features for which a geographic feature amount is stored in the geographic feature amount database are planimetric features allocated to each tile one by one at a maximum zoom level, and the planimetric feature information stored in the planimetric feature database indicates a planimetric feature allocated to each tile one by one at the maximum zoom level. For this reason, the number of planimetric features is reduced, and capacity of both the databases can be reduced. Furthermore, since the number of planimetric features is reduced, a geographic feature amount can be calculated at high speed.

In the information processing method, the geographic feature amount may include at least one of a distance between the current position and each planimetric feature, and an elevation difference between the current position and each planimetric feature.

According to the present configuration, it is possible to determine reachability to each planimetric feature in consideration of at least one of a distance between the current position and each planimetric feature, and an elevation difference between the current position and each planimetric feature.

In the information processing method, the request may include additional information including at least one of vehicle information, user information, current time, and weather information, and the information processing method may further include, in determination of the reachability, determining the reachability by the vehicle to each planimetric feature based on the additional information.

According to this configuration, reachability to each planimetric feature can be determined in consideration of at least one of vehicle information, user information, current time, and weather information.

In the information processing method, the remaining energy information may be a remaining power amount or remaining fuel of the vehicle.

According to the present configuration, since reachability to each planimetric feature is calculated in consideration of a remaining power amount or remaining fuel, reachability to each planimetric feature can be determined in an electric vehicle or a gasoline vehicle.

In the information processing method, the planimetric feature database may include a first table that stores the tile ID and a second table that stores the planimetric feature information, and one piece of the planimetric feature information stored in the second table may be associated with one or a plurality of tile IDs among the tile IDs stored in the first table.

In a case where the planimetric feature database is configured by associating one piece of planimetric feature information with one tile ID, the planimetric feature database redundantly stores the same planimetric feature information. According to the present configuration, one piece of planimetric feature information stored in the second table is associated with one or a plurality of tile IDs among the tile IDs stored in the first table. For this reason, in the second table, one piece of planimetric feature information can be stored for one planimetric feature, and a plurality of pieces of planimetric feature information do not need to be stored for the same planimetric feature redundantly.

The information processing method may further include, in each piece of the response processing, extracting the planimetric feature information for, in addition to a first tile within a display range of the display device, a second tile positioned around the display range, calculating the geographic feature amount of the planimetric feature indicated by the planimetric feature information that is extracted, determining the reachability based on the geographic feature amount and the remaining energy information, and outputting the reachability that is determined and the planimetric feature information that is extracted.

According to the present configuration, in a case where the user scrolls or zooms out the display range, the display device can quickly display a planimetric feature located in a tile to be displayed in the display range and reachability of the planimetric feature.

In the information processing method, the second tile may be a tile surrounding the display range, and may be a tile located on the outer side by m (m is an integer of one or more) tiles from an outer periphery of the display range.

According to the present configuration, in a case where the user scrolls or zooms out a display screen, the display device can quickly display a planimetric feature located in a tile to be displayed in the display range and reachability of the planimetric feature.

In the information processing method, each request may further include a traveling direction of the vehicle, and the second tile may be a tile in a traveling direction of the vehicle.

According to the present configuration, in a case where a display screen is scrolled in a traveling direction of the vehicle, the display device can quickly display a planimetric feature located in a tile to be displayed in the display range and reachability of the planimetric feature.

In the information processing method, the second tile may be a tile including a planimetric feature having the reachability that is substantially zero.

According to this configuration, when the user inputs an operation of displaying the boundary portion of the travelable range, the display device can quickly display the planimetric feature located in the tile at the boundary portion and the reachability of the planimetric feature.

The information processing method may further include, in the output, determining priority order of tiles such that a tile in which the planimetric feature having the reachability that is low is located is high in display order, and outputting preferentially the planimetric feature information and the reachability of a feature located in a tile that is high in the priority order.

According to the present configuration, the user can preferentially recognize a place of low reachability and which place is a limit of a travelable range.

In the information processing method, each request may further include a traveling direction of the vehicle, and the information processing method may further include, in the output, determining priority order of tiles such that a tile in the traveling direction is high in display order, and outputting preferentially the planimetric feature information and the reachability of a planimetric feature located in a tile that is high in the priority order.

According to the present configuration, the user can preferentially recognize reachability of a planimetric feature in the traveling direction.

The information processing method may further include, in the output, determining priority order of tiles such that a tile close to the current position is high in display order, and outputting preferentially the planimetric feature information and the reachability of a planimetric feature located in a tile that is high in the priority order.

According to the present configuration, the user can recognize reachability preferentially from an earlier place to which the vehicle possibly moves.

The information processing method may further include determining priority order of tiles such that a tile including a road as a planimetric feature is high in display order, and outputting preferentially the planimetric feature information and the reachability of a planimetric feature located in a tile that is high in the priority order.

According to the present configuration, the user can recognize a road and a route related to reachability before a place not related to reachability.

An information processing device according to another aspect of the present disclosure is an information processing device that controls a display device that displays a map image divided into a plurality of tiles according to a zoom level, each tile being assigned with a tile ID. The information processing device includes an acquisition unit that acquires, from the display device, a plurality of requests corresponding to each of a plurality of tiles displayed on the display device, each of the requests including the tile ID, a current position of a vehicle, and remaining energy information of the vehicle, and a parallel processing unit that executes, in parallel, a plurality of pieces of response processing corresponding to a plurality of the requests that are acquired. In each piece of the response processing, planimetric feature information indicating a feature to be displayed on each tile, the planimetric feature information corresponding to the tile ID included in a request, is extracted from a planimetric feature database in which the tile ID and the planimetric feature information are associated with each other, based on the planimetric feature information that is extracted, a geographic feature amount between the current position and each feature is calculated, reachability by the vehicle to the planimetric feature is determined based on the geographic feature amount that is calculated and the remaining energy information, and the reachability that is determined and the planimetric feature information that is extracted are output to the display device.

An information processing program according to still another aspect of the present disclosure is an information processing program that causes a computer to function as an information processing device that controls a display device that displays a map image divided into a plurality of tiles according to a zoom level, each tile being assigned with a tile ID. The information processing program causes a computer to function as an acquisition unit that acquires, from the display device, a plurality of requests corresponding to each of a plurality of tiles displayed on the display device, each of the requests including the tile ID, a current position of a vehicle, and remaining energy information of the vehicle, and a parallel processing unit that executes, in parallel, a plurality of pieces of response processing corresponding to a plurality of the requests that are acquired. In each piece of the response processing, planimetric feature information indicating a feature to be displayed on each tile, the planimetric feature information corresponding to the tile ID included in a request, is extracted from a planimetric feature database in which the tile ID and the planimetric feature information are associated with each other, based on the planimetric feature information that is extracted, a geographic feature amount between the current position and each planimetric feature is calculated, reachability by the vehicle to the planimetric feature is determined based on the geographic feature amount that is calculated and the remaining energy information, and the reachability that is determined and the planimetric feature information that is extracted are output to the display device.

According to these configurations, the same action and effect as those of the information processing method can be obtained.

It is needless to say that the present disclosure allows such an information processing program to be distributed using a computer-readable non-transitory recording medium such as a CD-ROM, or via a communication network such as the Internet.

Each embodiment described below illustrates a specific example of the present disclosure. Numerical values, shapes, components, steps, order of steps, and the like shown in the embodiment below are merely examples, and are not intended to limit the present disclosure. Further, among constituent elements in the embodiment below, a constituent element that is not described in an independent claim indicating the highest concept is described as an optional constituent element. Further, in all embodiments, pieces of content can be combined.

### EMBODIMENT

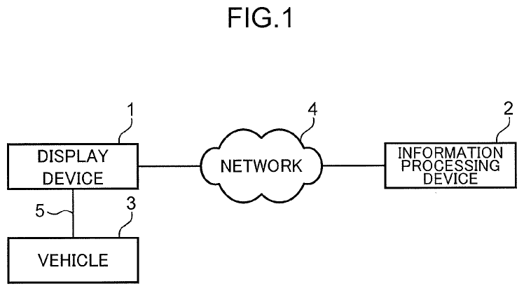

FIG. 1 is a diagram illustrating an example of an entire configuration of an information processing system according to an embodiment of the present disclosure. The information processing system includes a display device 1, an information processing device 2, and a vehicle 3. The display device 1 and the information processing device 2 are communicably connected to each other via a network 4. The network 4 includes, for example, a wide area communication network including an Internet communication network and a mobile phone communication network. The display device 1 and the vehicle 3 are connected via a communication path 5. The communication path 5 is, for example, a close proximity wireless communication path such as Bluetooth (registered trademark) or a wired communication path such as a universal serial bus (USB) cable. Note that the vehicle 3 may be communicably connected to the display device 1 and the information processing device 2 via the network 4 instead of the communication path 5.

The display device 1 displays a map image that is divided into a plurality of tiles according to a zoom level, in which a tile ID is assigned to each of the tiles. The display device 1 includes, for example, a mobile terminal such as a smartphone and a tablet terminal. The display device 1 is carried by the user in the vehicle 3. The display device 1 may include an in-vehicle terminal such as a car navigation system mounted on the vehicle 3. The display device 1 transmits a request to the information processing device 2.

The information processing device 2 includes, for example, a cloud server including one or a plurality of computers. The information processing device 2 receives a request from the display device 1, executes response processing, and transmits a response result to the response processing to the display device 1. The response result includes planimetric feature information, reachability, and the like.

The vehicle 3 is configured as, for example, an electric vehicle, and transmits various types of information to the display device 1. The electric vehicle may be not only an electric vehicle in a narrow sense but also a plug-in hybrid vehicle. Further, the vehicle 3 may be, for example, an electric motorcycle, an electric assist bicycle, or an electric kick scooter.

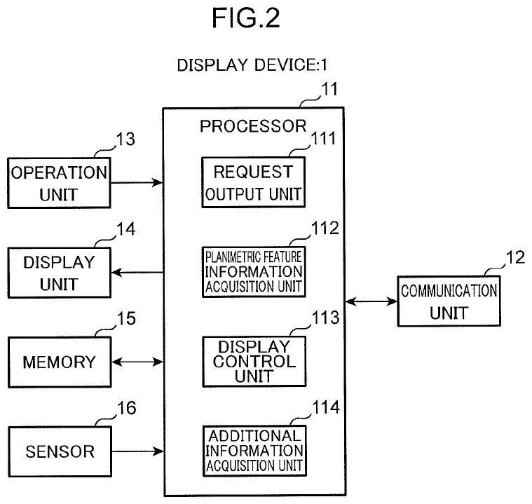

FIG. 2 is a block diagram illustrating an example of a configuration of the display device 1 illustrated in FIG. 1. The display device 1 includes a processor 11, a communication unit 12, an operation unit 13, a display unit 14, a memory 15, and a sensor 16.

The processor 11 includes an electric circuit such as a CPU or an ASIC. The processor 11 includes a request output unit 111, a planimetric feature information acquisition unit 112, a display control unit 113, and an additional information acquisition unit 114.

The request output unit 111 outputs a plurality of requests corresponding to each of a plurality of tiles displayed on the display unit 14 to the information processing device 2 using the communication unit 12. The request includes, for example, a tile ID, a current position of the vehicle 3, and a remaining power amount of the vehicle 3 (an example of remaining energy information). The tile ID is an identifier of each tile constituting a map image. As the current position of the vehicle 3, for example, a current position of the display device 1 detected by the sensor 16 or a current position of the vehicle 3 acquired from the vehicle 3 can be employed. As the remaining power amount of the vehicle 3, for example, a remaining power amount of a battery of the vehicle 3 acquired from the vehicle 3 can be employed. Note that the request may include additional information to be described later. The additional information may include vehicle information, user information, and auxiliary information described later.

In the present embodiment, a map image is constituted of a plurality of tiles corresponding to a zoom level. The zoom level is a numerical value indicating the number of divisions of the map image. In a case where the zoom level is zero, the map image is constituted of one tile representing the entire world map, in a case where the zoom level is one, the map image is constituted of four tiles obtained by dividing the world map into four, and in a case where the zoom level is two, the map image is constituted of sixteen tiles obtained by dividing the world map into sixteen. As the zoom level increases in this manner, the number of divisions of the world map increases. Therefore, as the zoom level increases, an area covered by one tile becomes smaller, but detailed planimetric features can be displayed accordingly.

When the zoom level is z, a tile ID is represented by three-component data of (x, y, z). Here, x is a numerical value indicating a position of a corresponding tile from the left end when the world map is divided at the zoom level z. The value y is a numerical value indicating a position of a corresponding tile from the upper end when the world map is divided at the zoom level z.

Note that, as a shape of the tile, for example, a quadrangle such as a square or a rectangle is employed. However, this is an example, and the shape of the tile may be a polygon other than a quadrangle such as a triangle or a hexagon.

The planimetric feature information acquisition unit 112 uses the communication unit 12 to acquire, from the information processing device 2, a response result calculated by response processing to a request. The response result includes planimetric feature information indicating a planimetric feature to be displayed on each tile, and reachability by a vehicle to a planimetric feature indicated by the planimetric feature information.

The planimetric feature is, for example, an object displayed on a map image such as a road or a building. In the present embodiment, the map image is a background map image indicating a topography of the ground. A final map image is generated as a planimetric feature is superimposed on the background map image. Hereinafter, this final map image is referred to as a superimposed map image. The reachability is information indicating whether or not the vehicle 3 can reach each planimetric feature displayed in the superimposed map image. As the reachability, a binary value such as “1” in a case where a planimetric feature is reachable and “0” in a case where a feature is unreachable may be employed, or a continuous value such as 0% to 100% may be employed.

The display control unit 113 generates a superimposed map image by superimposing and displaying reachability and a planimetric feature indicated by acquired planimetric feature information on a map image, and displays the generated superimposed map image on the display unit 14.

The additional information acquisition unit 114 acquires vehicle information from the vehicle 3 using the communication unit 12. The vehicle information includes, for example, at least one of a vehicle ID, a vehicle type, a load weight, and a traveling mode. The vehicle ID is an identifier of a vehicle. The vehicle type is information indicating a type of the vehicle 3, and for example, information such as a sedan and SUV may be employed, or information indicating a product name of the vehicle 3 may be employed. The load weight indicates the weight of a load of the vehicle 3. The load includes a passenger and baggage. The traveling mode includes modes set in the vehicle 3 such as an energy saving mode, a normal mode, and a power mode.

Further, the additional information acquisition unit 114 acquires user information based on operation of the user received by the operation unit 13. The user information includes at least one of a user ID, a gender, and a weight. The user ID is an identifier of the user. As the user ID, any information may be employed as long as the information can uniquely identify the user, such as a mobile phone number and an email address. The gender is the gender of the user who possesses the display device 1 or the vehicle 3. The weight is the weight of the user who possesses the display device 1 or the vehicle 3.

Furthermore, the additional information acquisition unit 114 acquires auxiliary information. The auxiliary information is information that affects reachability by the vehicle 3, and includes, for example, at least one of a current time and weather information. The additional information acquisition unit 114 preferably acquires a current time by using, for example, a clock function included in the processor 11. The additional information acquisition unit 114 preferably makes an access to a weather forecast server using, for example, the communication unit 12 and acquires weather information indicating current weather from the weather forecast server.

The communication unit 12 includes a communication circuit that connects the display device 1 to the network 4 and a communication circuit that connects the display device 1 to the communication path 5. The communication unit 12 transmits a request to the information processing device 2 and receives a response result to the request from the information processing device 2. Further, the communication unit 12 receives a map image from the information processing device 2. Furthermore, the communication unit 12 receives vehicle information from the vehicle 3.

The operation unit 13 includes, for example, a touch panel, and receives various types of operation input by the user. The input operation includes operation of inputting the user information described above, operation of designating a display range of a map image, and the like.

The display unit 14 includes, for example, a liquid crystal display or an organic EL display. The display unit 14 displays a superimposed map image generated by the display control unit 113.

The memory 15 includes a nonvolatile storage device such as a flash memory. The memory 15 may store, for example, information (for example, a vehicle ID and a vehicle type) that does not dynamically change among user information and vehicle information.

The sensor 16 includes, for example, a GPS sensor, and acquires a current position of the display device 1.

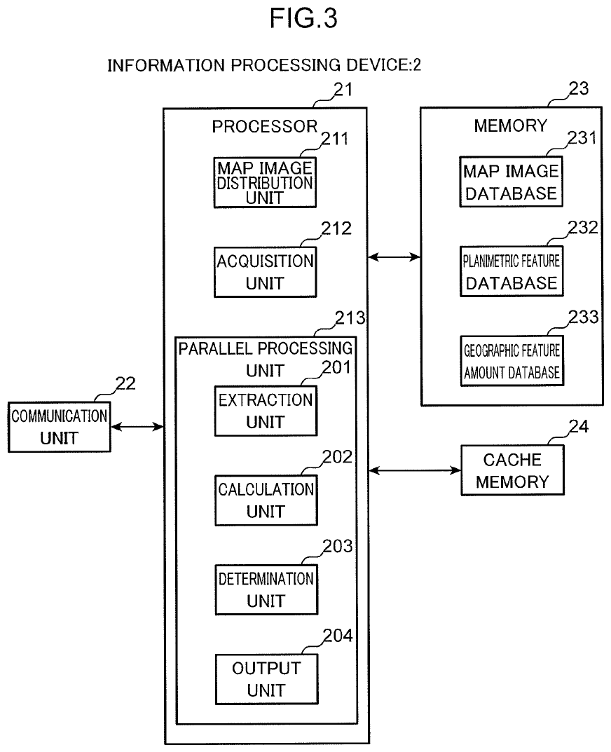

FIG. 3 is a block diagram illustrating an example of a configuration of the information processing device 2 illustrated in FIG. 1.

The information processing device 2 includes a processor 21, a communication unit 22, a memory 23, and a cache memory 24.

The processor 21 includes an electric circuit such as a CPU and includes a map image distribution unit 211, an acquisition unit 212, and a parallel processing unit 213. Each block of the map image distribution unit 211 to the parallel processing unit 213 is realized by the CPU executing an information processing program.

The map image distribution unit 211 reads, from a map image database 231, a tile of a map image corresponding to each of a plurality of requests transmitted from the display device 1 and acquired by the acquisition unit 212, and transmits the read tile to the display device 1 using the communication unit 22. Here, the map image distribution unit 211 reads a plurality of tiles corresponding to a plurality of requests, and executes processing of transmitting a plurality of the read tiles in parallel. By the above, a plurality of tiles corresponding to the request can be promptly displayed on the display device 1. Specifically, the map image distribution unit 211 preferably reads a tile corresponding to a tile ID included in each request from the map image database 231. The map image database 231 stores a tile ID and a tile in association with each other.

The acquisition unit 212 acquires a plurality of requests transmitted from the display device 1 using the communication unit 22, and inputs a plurality of the acquired requests to the map image distribution unit 211 and the parallel processing unit 213.

The parallel processing unit 213 executes a plurality of pieces of response processing corresponding to a plurality of requests acquired by the acquisition unit 212 in parallel. The parallel processing unit 213 includes an extraction unit 201, a calculation unit 202, a determination unit 203, and an output unit 204. The extraction unit 201 to the output unit 204 execute a plurality of pieces of response processing for a plurality of requests in parallel.

The extraction unit 201 extracts planimetric feature information corresponding to a tile ID included in a request from a planimetric feature database 232. The planimetric feature database 232 is a database that stores a tile ID and planimetric feature information indicating a planimetric feature to be displayed on each tile in association with each other.

Here, the extraction unit 201 stores the extracted planimetric feature information in the cache memory 24 in association with a tile ID. After the above, in a case where planimetric feature information corresponding to a tile ID included in a request is stored in the cache memory 24, the extraction unit 201 extracts the planimetric feature information from the cache memory 24. On the other hand, in a case where planimetric feature information corresponding to a tile ID included in a request is not stored in the cache memory 24, the extraction unit 201 extracts the planimetric feature information from the planimetric feature database 232. In this manner, planimetric feature information frequently extracted is extracted from the cache memory 24, and response time can be further reduced.

The calculation unit 202 calculates a geographic feature amount between a current position of the vehicle 3 included in a request and a planimetric feature indicated by extracted planimetric feature information based on planimetric feature information extracted by the extraction unit 201. As the geographic feature amount, for example, a distance between a current position of the vehicle 3 and a planimetric feature can be employed. As the distance, for example, a distance of a path from a current position of the vehicle 3 to a planimetric feature is employed. Usually, the extraction unit 201 extracts a plurality of pieces of planimetric feature information. For this reason, the calculation unit 202 calculates a distance from a current position of the vehicle 3 for each of a plurality of planimetric features indicated by a plurality of pieces of extracted planimetric feature information.

Here, the calculation unit 202 preferably calculates a distance between a current position of the vehicle 3 and a planimetric feature with reference to a geographic feature amount database 233. The geographic feature amount database 233 stores a geographic feature amount between each of a plurality of predetermined planimetric feature and a reachable predetermined main planimetric feature. In this manner, even in a case where the current position is not included in a tile, the calculation unit 202 can calculate a geographic feature amount between the current position of the vehicle 3 and a planimetric feature.

Note that the distance may be a straight line distance between a current position of the vehicle 3 and a planimetric feature. The geographic feature amount may be an elevation difference between a current position of the vehicle 3 and a planimetric feature.

The determination unit 203 determines reachability to a planimetric feature by the vehicle 3 based on a geographic feature amount calculated by the calculation unit 202 and a remaining power amount included in a request. Here, the determination unit 203 preferably determines reachability by using a machine learning model in which a geographic feature amount and a remaining power amount are used as input data and reachability is used as output data. The machine learning model is a model created in advance by performing supervised learning in which a data set of a geographic feature amount, a remaining power amount, and reachability is used as learning data and reachability is used as training data. In a case where a distance is employed as a geographic feature amount, the learning data includes a distance as a geographic feature amount. In a case where an elevation difference is employed as a geographic feature amount, the learning data includes an elevation difference as a geographic feature amount. In a case where a distance and an elevation difference are employed as geographic feature amounts, the learning data includes a distance and an elevation difference as geographic feature amounts.

As the machine learning model, for example, a neural network a model based on a decision tree such as LightGBM, or a multiple regression analysis model can be employed.

Note that input data of the machine learning model may include the above-described additional information. Specifically, at least one of vehicle information, user information, and auxiliary information may be employed as the input data. In a case where vehicle information is employed as the input data, the input data includes at least one of a vehicle ID, a vehicle type, a load weight, and a traveling mode. In a case where user information is employed as the input data, the input data includes at least one of a user ID, a gender, and a weight. In a case where auxiliary information is employed as the input data, the input data includes at least one of a current time and weather information. In a case where additional information is included in the input data, the machine learning model further includes the additional information as learning data in addition to a geographic feature amount and a remaining power amount, and is created by machine learning using the learning data. Note that, in the machine learning model, it is considered that determination accuracy of reachability is improved as the number of types of input data increases.

The output unit 204 transmits reachability determined by the determination unit 203 and planimetric feature information extracted by the extraction unit 201 to the display device 1 using the communication unit 22.

The communication unit 22 includes a communication circuit that connects the information processing device 2 to the network 4. The communication unit 22 receives a request transmitted from the display device 1. Further, the communication unit 22 transmits reachability and planimetric feature information to the display device 1. Furthermore, the communication unit 22 transmits a plurality of tiles read from the map image database 231 by the map image distribution unit 211.

The memory 23 includes, for example, a nonvolatile storage device such as an SSD and an HDD. The memory 23 stores the map image database 231, the planimetric feature database 232, and the geographic feature amount database 233.

The cache memory 24 includes, for example, a RAM, a flash memory, or the like, and stores planimetric feature information extracted by the extraction unit 201 in association with a tile 1D. Note that a part of a storage area of the memory 23 may be used as the cache memory 24.

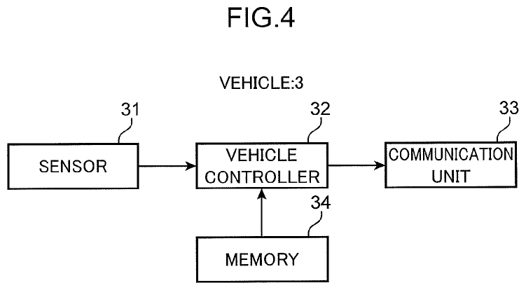

FIG. 4 is a diagram illustrating an example of a configuration of the vehicle 3 illustrated in FIG. 1. The vehicle 3 includes a sensor 31, a vehicle controller 32, a communication unit 33, and a memory 34. The sensor 31 includes a GPS sensor, a battery sensor, and a weight sensor. The GPS sensor detects a current position of the vehicle 3. The battery sensor detects a remaining power amount of a battery serving as a power source of the vehicle 3. The weight sensor detects a load weight of the vehicle 3.

The vehicle controller 32 includes, for example, a computer, and performs overall control of the vehicle 3. The vehicle controller 32 transmits a current position of the vehicle 3 detected by the GPS sensor to the display device 1 using the communication unit 33. The vehicle controller 32 transmits a remaining power amount of the battery detected by the battery sensor to the display device 1 using the communication unit 33. The vehicle controller 32 acquires a load weight detected by the weight sensor. The vehicle controller 32 acquires a vehicle ID and a vehicle type from the memory 34. The vehicle controller 32 sets a traveling mode of the vehicle 3 according to operation of the user in the vehicle 3. Then, the vehicle controller 32 generates vehicle information including at least one of a vehicle ID, a vehicle type, a load weight, and a traveling mode, and transmits the generated vehicle information to the display device 1 using the communication unit 33.

The memory 34 includes a nonvolatile storage device such as a flash memory, and stores a vehicle ID and a vehicle type.

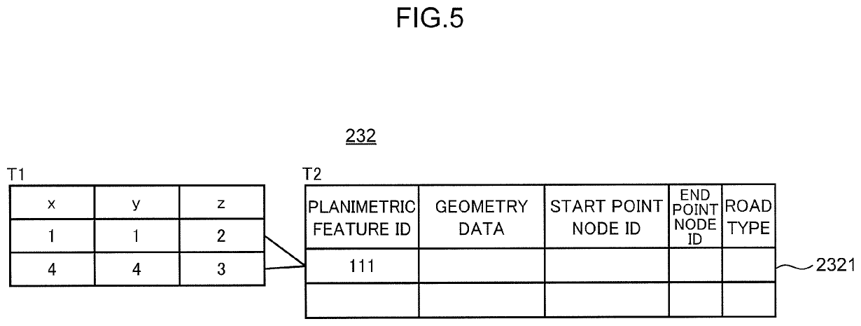

FIG. 5 is a diagram illustrating an example of a data configuration of the planimetric feature database 232. The planimetric feature database 232 includes a first table T1 and a second table T2. The first table T1 stores a tile ID. Here, the first table T1 stores tile IDs of all tiles constituting a map image. In a first row of the first table T1, a tile ID of (x, y, z)=(1, 1, 2) is stored. This tile ID indicates a tile ID of a tile which is a first one from the left end and a first one from the upper end among 16 tiles constituting a map image with a zoom level of two.

The second table T2 stores a plurality of pieces of planimetric feature information 2321. The planimetric feature information 2321 stores a planimetric feature ID, geometry data, a start point node ID, an end point node ID, and a road type in association with each other.

The planimetric feature ID is an identifier for uniquely identifying a plurality of planimetric features scheduled to be displayed in a superimposed map image. The geometry data is data indicating a shape of a planimetric feature. In a case where a planimetric feature is a road, the geometry data includes a plurality of points indicating the shape of the road. When a planimetric feature is a building, the geometry data includes a plurality of points indicating an outer edge shape when the building is viewed from above. Each of a plurality of points constituting the geometry data includes position information including latitude and longitude.

The start point node ID is an identifier of a start point node. In a case where a planimetric feature is a road, the start point node indicates a start point of the road. In a case where a planimetric feature is a road, the start point node is a representative node of the road. Therefore, in a case of calculating a geographic feature amount from a current position to a road, the calculation unit 202 preferably calculates a geographic feature amount from a current position to the start point node of the road. In a case where a planimetric feature is a building, the start point node indicates a representative node of the building. Therefore, when calculating a geographic feature amount from a current position to a building, the calculation unit 202 preferably calculates a geographic feature amount from a current position to the representative node of the building.

The end point node ID is an identifier of an end point node. In a case where a planimetric feature is a road, the end point node indicates an end point of the road. In a case where a planimetric feature is a building, the end point node is blank.

A representative position on a road such as an intersection is employed as the start point node. As the end point node, a representative position on a road such as an intersection and a dead end point is employed. Note that, depending on a zoom level, some roads do not include an intersection in a tile. In this case, for example, a position of a road at the left end in the tile is employed as the start point node, and a position of a road at the right end in the tile is employed as the end point node.

The road type is information indicating a type of a road. The road type includes, for example, information indicating an expressway, a national road, a main road, a branch road, the number of lanes, and the like.

In a case where planimetric feature information is stored for each tile ID, there may be a case where the planimetric feature database 232 redundantly stores a plurality of pieces of the planimetric feature information 2321 indicating the same planimetric feature. In view of the above, in the present embodiment, one piece of the planimetric feature information 2321 stored in the second table T2 is associated with one or a plurality of tile IDs among tile IDs stored in the first table T1. In this manner, in the second table T2, one piece of the planimetric feature information 2321 can be stored for one planimetric feature, and planimetric feature information indicating the same planimetric feature does not need to be stored redundantly.

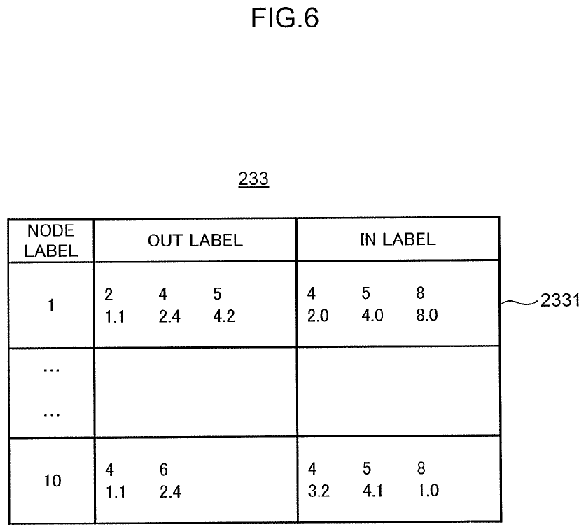

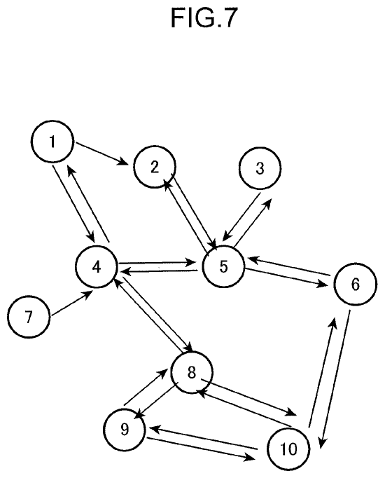

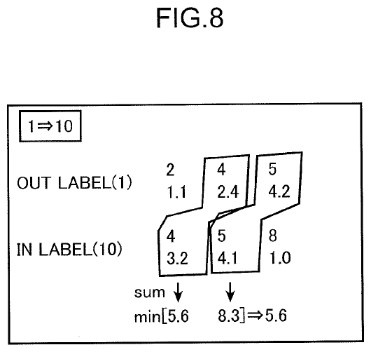

FIG. 6 is a diagram illustrating an example of a data configuration of the geographic feature amount database 233. FIG. 7 is a graph illustrating a connection relationship of nodes stored in the geographic feature amount database 233 illustrated in FIG. 6. FIG. 8 is a diagram illustrating a calculation example of a geographic feature amount from a node “1” to a node “10” in the geographic feature amount database 233 illustrated in FIG. 6.

Referring to FIG. 6, the geographic feature amount database 233 stores a plurality of pieces of geographic feature amount information 2331. Specifically, the geographic feature amount information 2331 includes fields of a node label, an out label, and an in label. The node label is an identifier of a node indicating a position of each planimetric feature to be displayed in the present embodiment. Hereinafter, a node indicated by the node label is referred to as an own node. Further, a node connected to an own node via one or more edges is referred to as a counterpart node. A field of the out label includes an identifier of a counterpart node reachable from an own node and a geographic feature amount of movement between them. The in label includes an identifier of a counterpart node that can reach an own node and a geographic feature amount of movement between them. In the present embodiment, a start point node ID stored in the second table T2 is employed as each of the node label, the out label, and the in label. In a simplest form, it is necessary to store all counterpart nodes reachable from an own node, but a method of calculating a geographic feature amount of movement between optional two points by selecting and storing only some main counterpart nodes is proposed in a document described later, and the present embodiment employs this method.

In FIG. 7, an arrow connecting nodes indicate a direction in which the vehicle 3 can move. In the example of FIG. 7, nodes “2”, “4”, and “5” are included as counterpart nodes reachable from a node “1”. For this reason, in a field of an out label of the node “1”, geographic feature amounts from the node “1” to the nodes “2”, “4”, and “5” are stored. Here, a distance between an own node and a counterpart node is employed as a geographic feature amount. Further, nodes “4”, “5”, and “8” are included as counterpart nodes that can reach the node “1”. For this reason, a distance from each of the nodes “4”, “5”, and “8” to the node “1” is stored in a field of an in label of the node “1”.

Similarly, for a node “10”, a distance of each of the nodes “4” and “6” is stored in an out label field, and a distance of each of the nodes “4”, “5”, and “8” is stored in the in label field.

Processing in which the calculation unit 202 calculates a distance from the node “1” to the node “10” will be described with reference to FIG. 8. In the example of FIG. 6, “1.1”, “2.4”, and “4.2” are stored as distances of the nodes “2”, “4”, and “5”, respectively, in a field of an out label of the node “1”. Further, in a field of an in label of the node “10”, “3.2”, “4.1”, and “1.0” are stored as distances of the nodes “4”, “5”, and “8”, respectively. In both of the fields, the nodes “4” and “5” are common. In view of the above, the calculation unit 202 combines the node “1” and the node “10” through the nodes “4” and “5” stored in common in both of the fields, and extracts a candidate path.

Here, a first path from the node “1” to the node “10” via the node “4” and a second path from the node “1” to the node “10” via the node “5” are extracted. A total value of distances of the first path is “5.6”, and a total value of distances of the second path is “8.3”. For this reason, the calculation unit 202 calculates, as a distance from the node “1” to the node “10”, the total value “5.6” of the first path having a shorter distance between the first path and the second path. In this manner, in a case where a current position is the node “1” and a start point node of one planimetric feature included in one tile to be calculated is the node “10”, the calculation unit 202 can calculate a distance from the current position to the one planimetric feature as “5.6”. The calculation unit 202 calculates a distance from a current position to each planimetric feature by applying such processing to each planimetric feature included in a tile to be calculated.

Such an algorithm in which a distance of a main node is stored in a database in advance and a distance between optional nodes is calculated is publicly known. This algorithm is disclosed in, for example, a document “Takuya Akiba, Yoichi Iwata, Yuichi Yoshida, Improvement in Efficiency of Graph Shortest Path Query Processing by Direct Calculation of 2-Hop Label, March 2014, DEIM Forum 2014, Internet <URL; https://db-event.jpn.org/deim2014/final/proceedings/A8-3.pdf”.

In a case where an elevation difference is employed as a geographic feature amount, the geographic feature amount database 233 preferably stores the elevation difference instead of a distance. Furthermore, in a case where a distance and an elevation difference are employed as geographic feature amounts, the geographic feature amount database 233 preferably stores the distance and the elevation difference. In this case, the calculation unit 202 only needs to extract a path where the sum of a total value of elevation differences and a total value of distances from the node “1” to the node “10” is minimized, and to calculate a distance and an elevation difference of the extracted path as geographic feature amounts from the node “1” to the node “10”.

Alternatively, the calculation unit 202 may extract a path (the above-described first path) having a minimum total value of distances from the node “1” to the node “10”, further calculate an elevation difference of the extracted first path, and calculate the distance and the elevation difference of the first path as geographic feature amounts from the node “1” to the node “10”.

Furthermore, the geographic feature amount database 233 may further store a road type and the number of intersections as geographic feature amounts. In this case, the geographic feature amount database 233 may store, for example, information on a road type and the number of intersections in addition to a distance between an own node and a counterpart node. As the road type, for example, a road type described in FIG. 5 can be employed. As the number of intersections, for example, the number of intersections existing on a path between an own node and a counterpart node can be employed. In this case, the calculation unit 202 only needs to calculate at least one of a road type and the number of intersections as geographic feature amounts in addition to at least one of a distance and an elevation difference of the path from the node “1” to the node “10” extracted by the above-described processing.

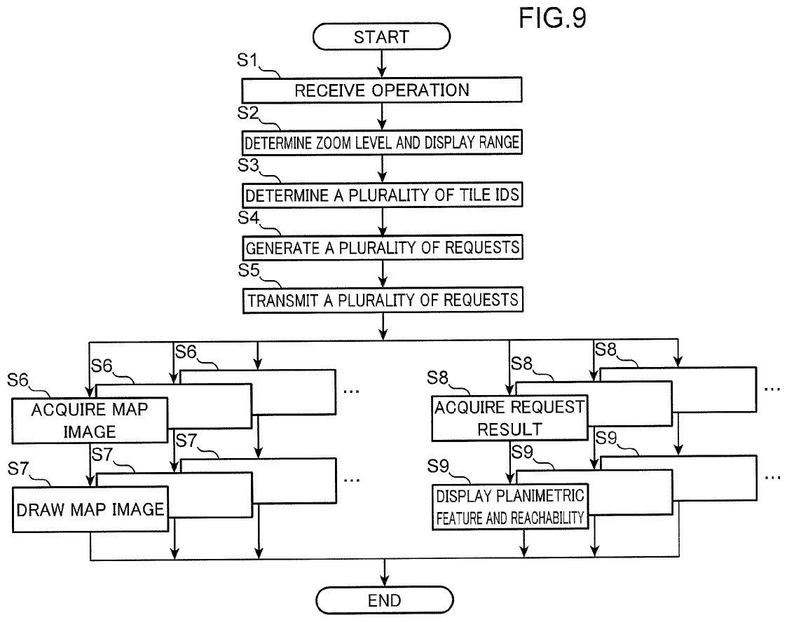

FIG. 9 is a flowchart illustrating an example of processing of the display device 1 according to the embodiment of the present disclosure. In step S1, the operation unit 13 receives operation of designating a display range of a map image from the user. For example, the user designates a display range by inputting at least one of pinch operation and swipe operation to a map image displayed on the display unit 14.

Here, the displayed map image may be, for example, a map image cached in the display device 1. Further, the map image may be a superimposed map image. Note that, when no map image is cached in the display device 1, the display device 1 may acquire a map image having a certain display range based on a current position of the vehicle 3 from the information processing device 2 and display the map image on the display unit 14.

To make a zoom level larger than a currently displayed map image, the user preferably inputs pinch-out operation, and to make a zoom level smaller than a currently displayed map image, the user preferably inputs pinch-in operation. Further, in a case of newly displaying a map image located on a certain one direction side with respect to a currently displayed map image, the user preferably inputs swipe operation in the one direction.

The display range is, for example, a quadrangular region defined by latitude and longitude of one vertex (for example, an upper right vertex) of a quadrangular display region of the display unit 14 and latitude and longitude of another one vertex (for example, a lower left vertex).

In step S2, the request output unit 111 determines a zoom level and a display range of a map image displayed on the display unit 14 based on an operation amount of the operation received in step S1. Here, the request output unit 111 determines a zoom level of a map image to be newly displayed based on the operation amount of pinch operation received in step S1 and a zoom level of a currently displayed map image. Furthermore, the request output unit 111 preferably determines a display range of the map image to be newly displayed based on the operation amount of swipe operation received in step S1, resolution of the display unit 14, a display range of a currently displayed map image, and a zoom level determined by pinch operation.

In step S3, the request output unit 111 determines a tile ID of each of a plurality of tiles to be displayed on the display unit 14 based on the zoom level and the display range determined in step S2. For example, the request output unit 111 divides the display range determined in step S2 into tiles of a predetermined row x a predetermined column that can be displayed at the zoom level determined in step S2, and determines a tile ID of each of the divided tiles.

In step S4, the request output unit 111 generates a plurality of requests corresponding to a plurality of the tile IDs determined in step S3. Each request includes a current position of the vehicle 3 and a remaining power amount of the vehicle 3 in addition to the determined tile ID.

In step S5, the request output unit 111 transmits a plurality of the requests generated in step S4 to the information processing device 2 using the communication unit 12.

Processing in steps S6 to S9 is executed in parallel for each of a plurality of the requests.

In step S6, the display control unit 113 uses the communication unit 12 to acquire a plurality of map images corresponding to a plurality of requests and transmitted from the information processing device 2.

In step S7, the display control unit 113 draws a plurality of map images on the display unit 14.

For example, in a case where n requests are transmitted, the display control unit 113 executes n processing sets including step S6 and step S7 corresponding to the n requests in parallel. In this manner, a map image including n tiles is displayed on the display unit 14.

In step S8, the planimetric feature information acquisition unit 112 uses the communication unit 12 to acquire a plurality of response results corresponding to a plurality of requests and transmitted from the information processing device 2. The response result includes planimetric feature information and reachability calculated by response processing.

In step S9, the display control unit 113 causes the display unit 14 to display a planimetric feature indicated by the planimetric feature information included in the response result and the reachability included in the response result.

For example, in a case where n requests are transmitted, the planimetric feature information acquisition unit 112 and the display control unit 113 execute n processing sets including step S8 and step S9 corresponding to the n requests in parallel. In this manner, the planimetric feature and the reachability are superimposed and displayed on a map image on the display unit 14.

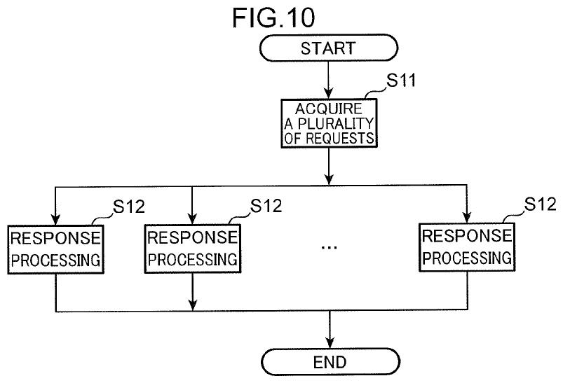

FIG. 10 is a flowchart illustrating an example of processing of the information processing device 2 according to the embodiment of the present disclosure. In step S11, the acquisition unit 212 acquires a plurality of requests transmitted from the display device 1 using the communication unit 22. Note that the acquisition unit 212 may cause the communication unit 22 to directly communicate with the vehicle 3 to periodically acquire a current position and a remaining power amount of the vehicle 3 from the vehicle 3. In this case, the acquisition unit 212 only needs to include a latest current position and a latest remaining power amount among current positions and remaining power amounts of the vehicle 3 periodically acquired from the vehicle 3 in the acquired request. Furthermore, in this case, the display device 1 can omit a current position and a remaining power amount of the vehicle 3 from the request.

In step S12, the parallel processing unit 213 executes a plurality of pieces of response processing corresponding to each of a plurality of the acquired requests.

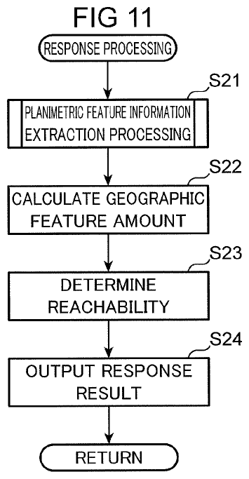

FIG. 11 is a flowchart illustrating details of the response processing illustrated in FIG. 10. In step S21, the extraction unit 201 executes planimetric feature information extraction processing. Details of the planimetric feature information extraction processing will be described later.

In step S22, the calculation unit 202 refers to the geographic feature amount database 233, and calculates a geographic feature amount between a planimetric feature indicated by the planimetric feature information extracted in step S21 and a current position of the vehicle 3. Hereinafter, description will be given assuming that a distance of a shortest path connecting the current position of the vehicle 3 and the planimetric feature is employed as the geographic feature amount. For example, when planimetric features A1 and A2 are included in a tile A to be calculated, a distance of a shortest path from the current position of the vehicle 3 to the planimetric feature A1 and a distance of a shortest path from the current position of the vehicle 3 to the planimetric feature A2 are calculated.

In step S23, the determination unit 203 inputs the distance of the shortest path of the planimetric feature calculated in step S22 and a remaining power amount included in a corresponding request to a machine learning model, and determines reachability of the planimetric feature. For example, in the above example, reachability to the planimetric feature A1 and reachability to the planimetric feature A2 are determined. A determination result may be, for example, a binary value or a continuous value as described above.

In step S24, the output unit 204 outputs a response result including the planimetric feature information extracted in step S21 and the reachability of each planimetric feature determined in step S23 to the display device 1 using the communication unit 22. In this manner, the display device 1 individually acquires a plurality of response results corresponding to a plurality of requests.

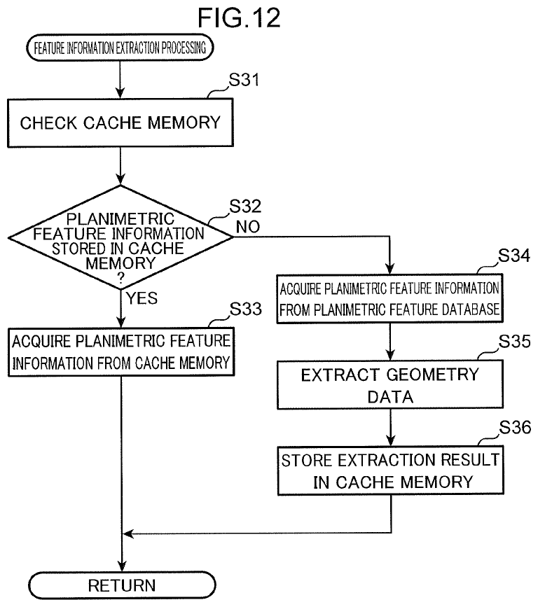

FIG. 12 is a flowchart illustrating details of the planimetric feature information extraction processing illustrated in FIG. 11. In step S31, the extraction unit 201 checks the cache memory 24.

In step S32, in a case where a request ID included in a request is stored in the cache memory 24 (YES in step S32), the extraction unit 201 acquires planimetric feature information associated with the request ID from the cache memory 24 (step S33).

On the other hand, in a case where the request ID included in the request is not stored in the cache memory 24 (NO in step S32), the extraction unit 201 acquires planimetric feature information corresponding to the request ID from the planimetric feature database 232 (step S34).

In step S35, geometry data corresponding to a zoom level is extracted from geometry data included in the feature information acquired in step S34.

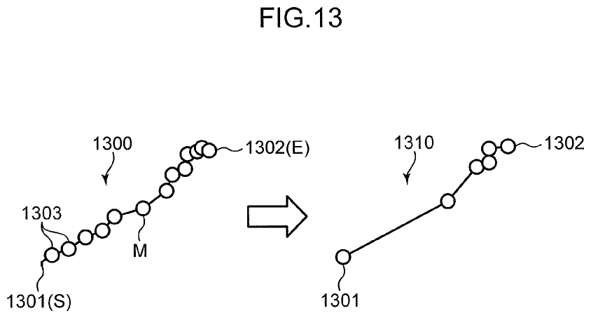

FIG. 13 is an explanatory diagram of processing for extracting geometry data. In FIG. 13, the left diagram illustrates geometry data 1300 before extraction, and the right diagram illustrates geometry data 1310 after extraction. The geometry data 1300 shows the geometry data 1300 for a road. The geometry data 1300 includes a plurality of points 1303 indicating a shape of the road from a start point node 1301 to an end point node 1302. The extraction unit 201 extracts the geometry data 1310 by applying, for example, a predetermined algorithm for thinning out unnecessary points to the geometry data 1300.

As an algorithm for thinning out unnecessary points, for example, a Douglas-Peucker algorithm can be employed. In a case where a wide-area map image at a small zoom level is displayed, if all the points 1303 constituting the geometry data 1300 are displayed, a data amount becomes excessive. Further, it is not possible to display all the points 1303 on the display unit 14 due to a limit of resolution. In view of the above, the extraction unit 201 extracts a plurality of points that can be displayed according to a zoom level from among a plurality of points constituting the geometry data 1300.

The Douglas-Peucker algorithm calculates distances between a straight line SE connecting a point S indicating the start point node 1301 and a point E indicating the end point node 1302 and all the points 1303 between them, and if a distance between a point M at a largest distance and the straight line SE is larger than a threshold, the points S, E, and M are determined as points to be extracted (step ST1). Next, the same processing as in step ST1 is repeated for the straight line SM and a straight line ME, and points to be extracted are determined (step ST2). After the above, similar processing is repeated, and a point to be finally extracted is determined.

When applying the Douglas-Peucker algorithm, the extraction unit 201 preferably extracts the point 1303 by employing a threshold determined in advance according to a zoom level. As the threshold, a distance per pixel of the display unit 14 can be employed at a corresponding zoom level. In this manner, the point 1303 required to be displayed in units of subpixels can be deleted from the geometry data 1300 to extract the geometry data 1310.

Alternatively, the extraction unit 201 may narrow down planimetric feature information to be displayed by deleting planimetric feature information indicating a small planimetric feature that is difficult to display according to a zoom level among pieces of the planimetric feature information extracted in step S34. For example, the extraction unit 201 may narrow down planimetric feature information to be displayed according to a zoom level based on a road type of the second table T2 illustrated in FIG. 5. In this case, the extraction unit 201 preferably narrows down planimetric feature information based on a deletion rule in which a relationship between a zoom level and a road type to be deleted according to the zoom level is associated in advance.

In step S36, the extraction unit 201 stores the planimetric feature information extracted in step S34 and having geometry data from which the point 1303 is deleted in step S35 in the cache memory 24 in association with a tile ID.

Note that, in a case where narrowing down of planimetric feature information according to a zoom level based on the road type is performed, the extraction unit 201 preferably stores the narrowed down planimetric feature information and a tile ID in the cache memory 24 in association with each other.

When the processing of step S33 or step S36 ends, the processing proceeds to step S22 of FIG. 11.

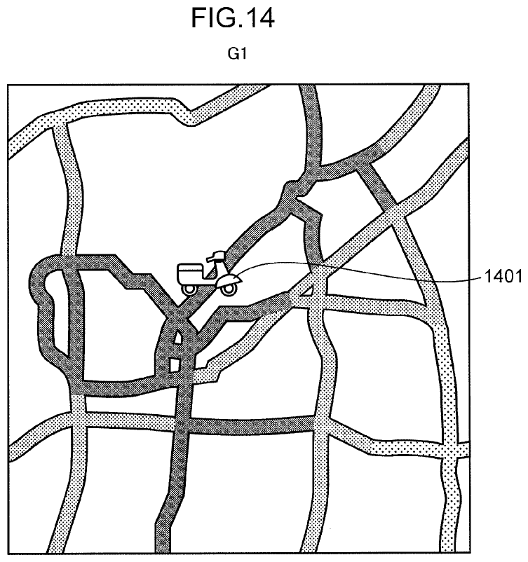

FIG. 14 is a diagram illustrating an example of a display screen G1 of a superimposed map image displayed on the display unit 14. In the display screen G1, a road is employed as a planimetric feature, and reachability of the road is indicated in three stages. Here, shading indicates a difference in color, and a road having a higher density indicates higher reachability. For example, a road with maximum density is assigned a color such as green, a road with intermediate density is assigned a color such as yellow, and a road with minimum density is assigned a color such as red.

An icon 1401 indicating a motorcycle indicates a current position of the vehicle 3. As described above, since the display screen G1 indicates reachability to a road by a difference in color, the user can easily check a reachable range. Note that the display screen G1 may display a remaining power amount of the vehicle 3. Furthermore, the display screen G1 may indicate reachability not only for a road but also for a planimetric feature other than a road such as a building. Furthermore, the display screen G1 may display reachability in a contour line shape based on a current position of the vehicle 3. Furthermore, the display screen G1 displays reachability in three stages, but this is an example, and reachability may be displayed in the number of stages other than three stages (for example, two stages, seven stages, ten stages, twenty stages, and the like).

As described above, according to the present embodiment, a plurality of requests corresponding to each of a plurality of tiles displayed by the display device 1 are acquired, and a plurality of pieces of response processing corresponding to a plurality of the acquired requests are executed in parallel. Then, in each piece of the response processing, a plurality of requests are acquired, planimetric feature information corresponding to the request is extracted from the planimetric feature database 232, a geographic feature amount between a current position of the vehicle 3 and each planimetric feature is calculated, reachability to each planimetric feature is determined based on the geographic feature amount and remaining energy information of the vehicle, and a determined reachable range and extracted planimetric feature information are output to the display device 1.

For this reason, for example, when the number of tiles displayed on the display device 1 is n, response time from issuance of a request to display of a reachable range on the display device is reduced to approximately 1/n as compared with a case where response processing is executed in series. As a result, response time can be shortened.

(First Modification)

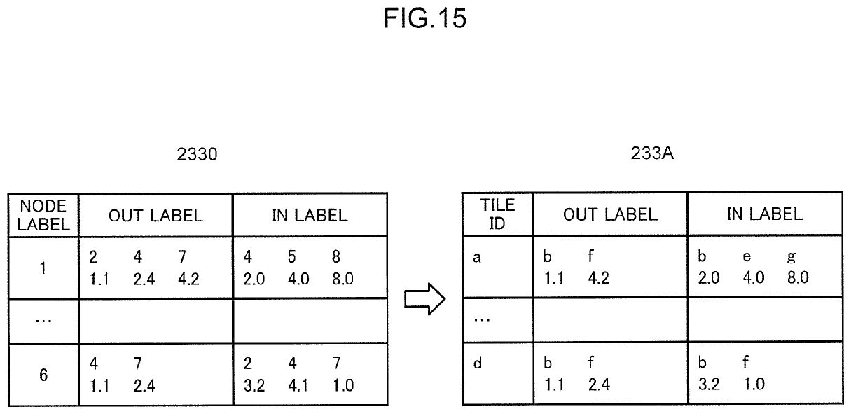

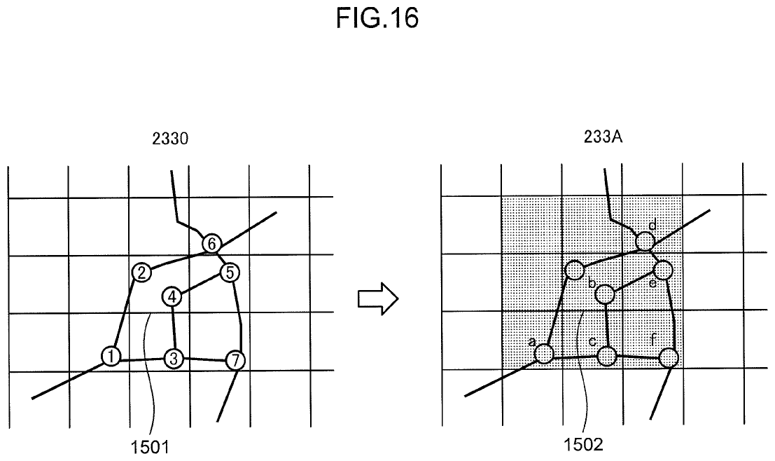

Next, a first modification of the embodiment of the present disclosure will be described. FIG. 15 is a diagram illustrating an example of a data configuration of each of a geographic feature amount database 2330 according to a comparative example of the present disclosure and a geographic feature amount database 233A according to the first modification. FIG. 16 is a graph illustrating a connection relationship of nodes for each of the geographic feature amount database 2330 and the geographic feature amount database 233A illustrated in FIG. 15.

Each of the two graphs illustrated in FIG. 16 illustrates a graph at a maximum zoom level among assumed zoom levels. For example, a value of about 18 can be employed as the maximum zoom level. In the comparative example, for example, a tile 1501 includes two nodes, a node “2” and a node “4”. Accordingly, in the geographic feature amount database 2330 illustrated in FIG. 15, the nodes “2” and “4” of the tile 1501 are included in a field of an out label of a node “1”, and the nodes “2” and “4” of the tile 1501 are included in a field of an in label of a node “6”.

As described above, the comparative example allows one tile to include a plurality of nodes. Here, as in the comparative example, in a case where a plurality of nodes are included in one tile at the maximum zoom level, since a plurality of the nodes are close to each other, there is no large difference in reachability. For this reason, there is no problem even if the nodes are aggregated into one node.

In view of the above, in the first modification, one node is allocated to each tile in the geographic feature amount database 233A at the maximum zoom level as illustrated in the right diagram of FIG. 15. For example, in a tile 1502, one of the two nodes included in the tile 1501 of the modification is omitted, and only a node “b” is allocated. Accordingly, as illustrated in the right diagram of FIG. 15, the nodes “b” and “f” are stored in a field of an out label of a node “a”, and the nodes “b” and “f” are stored in a field of an in label of the node “d”.

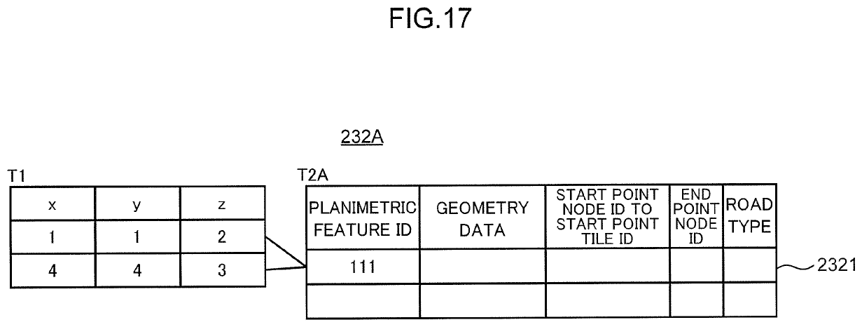

FIG. 17 is a diagram illustrating an example of a data configuration of a planimetric feature database 232A according to the first modification. In the first modification, since one node is allocated to one tile at the maximum zoom level, a start point node ID in the planimetric feature information 2321 can be uniquely specified by a tile ID of each tile at the maximum zoom level. In view of the above, in the first modification, a second table T2A constituting the planimetric feature database 232A stores a start point tile ID as a start point node ID. The start point tile ID indicates a tile ID of each tile at the maximum zoom level.

As described above, in the first modification, the number of planimetric features is reduced, and capacity of the geographic feature amount database 233A and the planimetric feature database 232A can be reduced. Furthermore, since the number of planimetric features is reduced, a geographic feature amount can be calculated at high speed.

(Second Modification)

In the above embodiment, the vehicle 3 is an electric vehicle. However, the present disclosure is not limited to this, and the vehicle 3 may be a gasoline vehicle. In this case, remaining fuel indicating an amount of gasoline remaining in the vehicle 3 can be employed as the remaining energy information. This makes it possible to present to the user whether each planimetric feature is reachable even in a gasoline vehicle.

(Third Modification)

In step S1 of FIG. 9, pinch operation and swipe operation are employed as operation of designating a display range of a map image, but the present disclosure is not limited to this, and operation of inputting latitude and longitude of an upper right vertex and lower left vertex defining a display range may be employed.

(Fourth Modification)

In FIG. 3, the information processing device 2 includes the map image distribution unit 211 and the map image database 231, but the present disclosure is not limited to this, and an external server connected to the network 4 may include the map image distribution unit 211 and the map image database 231. In this case, the display device 1 preferably transmits a request to the external server in addition to transmitting the request to the information processing device 2.

(Fifth Modification)

In FIG. 5, a start point node is employed as a representative node for a planimetric feature of a road, but the present disclosure is not limited this, and an end point node may be employed as the representative node. In this case, the geographic feature amount database 233 preferably employs an end point node as a node of a road.

(Sixth Modification)

In a sixth modification, reachability and feature information are output for a surrounding tile within a display range. In the sixth modification, the parallel processing unit 213 may execute a plurality of pieces of response processing in parallel so as to extract planimetric feature information for, in addition to a first tile within a display range of the display unit 14 of the display device 1, a second tile located around a display range, calculate a geographic feature amount of a planimetric feature indicated by the extracted planimetric feature information, determine reachability by the vehicle 3 from the calculated geographic feature amount and a remaining power amount of the vehicle 3, and output the determined reachability and the planimetric feature information determined and extracted. The first tile is a tile corresponding to a tile ID included in a plurality of requests output from the request output unit 111 of the display device 1. The second tile is a tile surrounding a display range, and is a tile located on the outer side by in (in is an integer of one or more) tiles from an outer periphery of the display range.

For example, when there are nine tiles (three (vertical) x three (horizontal)) in a display range, eighteen tiles surrounding the display range correspond to tiles on the outer side by one tile from an outer periphery of the display range. Note that tiles on the outer side by three tiles from the outer periphery of the display range correspond to the eighteen tiles surrounding the outer periphery of the display range, tiles further surrounding the outer side of these tiles, and tiles further surrounding the outer side of these times. Note that m is, for example, one to three.

In this case, the display control unit 113 of the display device 1 preferably first displays a superimposed map image corresponding to the first tile on the display unit 14, and in a case of receiving a scroll instruction or a zoom-out instruction from the user via the operation unit 13, displays a superimposed map image corresponding to the second tile included in the display range after scrolling or zoom-out on the display unit 14.

In this manner, in a case where the user scrolls or zooms out a superimposed map image, the display device 1 can quickly display a superimposed map image corresponding to a tile to be displayed in a display range.

(Seventh Modification)

In a seventh modification, the second tile described in the sixth modification is a tile in a traveling direction of a vehicle. A request output from the display device 1 further includes a traveling direction of the vehicle 3. The traveling direction of the vehicle 3 is represented by an angle with respect to a reference direction (for example, north).

In this case, the parallel processing unit 213 preferably identifies, as the second tile, a tile on a traveling direction of the vehicle 3 and on the outer side by m tiles from an outer periphery of a display range. In this manner, in a case where a display screen is scrolled in the traveling direction of the vehicle 3, the display device 1 can quickly display a superimposed map image corresponding to a tile to be displayed in a display range.

(Eighth Modification)

In an eighth modification, the second tile described in the sixth modification is a tile located around a display range and having substantially zero reachability.

In this case, the parallel processing unit 213 preferably identifies, as the second tile, a tile located on the outer side by m tiles from an outer periphery of a display range and having reachability equal to or less than a threshold. This threshold is an upper limit value of a range in which reachability can be regarded as substantially zero. In this manner, in a case where the user inputs operation of displaying a boundary portion of a travelable range via the operation unit 13, the display device 1 can quickly display a superimposed map image corresponding to a tile in the boundary portion.

(Ninth Modification)

In a ninth modification, the output unit 204 outputs reachability and planimetric feature information such that a tile in which a planimetric feature with low reachability is located is prioritized in display order. For example, the output unit 204 calculates an evaluation value of a tile for each of all tiles requested from the display device 1 based on reachability of a planimetric feature located in the tile. The evaluation value is, for example, an average value of reachability of planimetric features located in each tile. The output unit 204 determines priority order of tiles in the ascending order of evaluation values, and, in the descending order in the priority order of the tiles, outputs planimetric feature information of a planimetric feature located in the tiles and reachability of the planimetric feature to the display device 1. The display device 1 generates a superimposed map image in the order of received planimetric feature information and reachability, and displays the superimposed map image on the display unit 14.

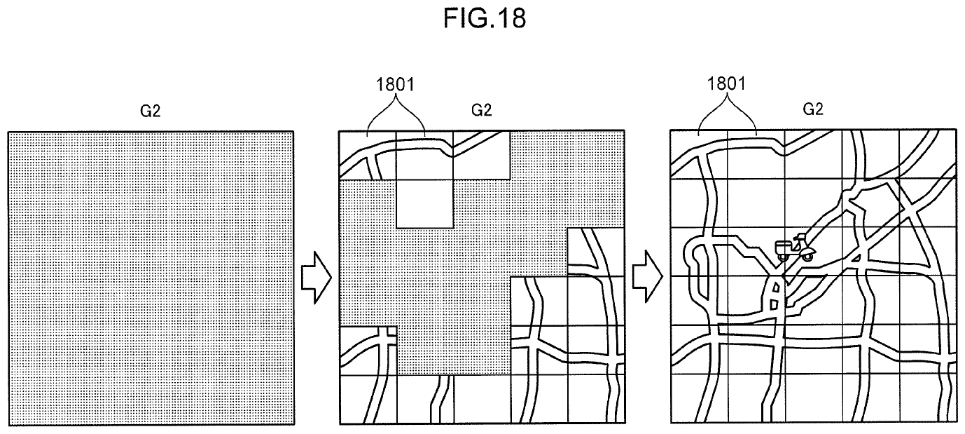

FIG. 18 is a diagram illustrating an example of a display screen G2 in the ninth modification of the present disclosure. On the display screen G2 illustrated on the left, since the display device 1 does not receive planimetric feature information or reachability, none of a superimposed map image 1801 is displayed. On the display screen G2 illustrated at the center, the superimposed map images 1801 are displayed in order from the superimposed map image 1801 of a tile in which a planimetric feature having low reachability is located. On the display screen G2 illustrated on the right, all the requested superimposed map images 1801 are displayed.

In this manner, the user can preferentially recognize a place of low reachability and which place is a limit of a travelable range.

Note that the output unit 204 may output planimetric feature information and reachability to be output in association with determined priority order. In this case, the display device 1 may generate the superimposed map image 1801 in the order of tiles in which a planimetric feature higher in priority order is located, and display the superimposed map image on the display unit 14. Further, in a case where reachability is displayed by a contour line, the output unit 204 preferably sets a tile including a boundary between a travelable place and a place that is not travelable to be high in priority order.

(Tenth Modification)

In a tenth modification, the output unit 204 outputs reachability and planimetric feature information such that a tile in a traveling direction of the vehicle 3 is prioritized in display order. In this case, a request output from the display device 1 further includes a traveling direction of the vehicle 3. The output unit 204 identifies a tile positioned in a traveling direction among all tiles requested from the display device 1. Then, the output unit 204 outputs planimetric feature information and reachability of a planimetric feature located in the identified tile in preference to planimetric feature information and reachability of a planimetric feature located in remaining tiles. The display device 1 generates a superimposed map image in order of receiving of planimetric feature information and reachability, and displays the superimposed map image on the display unit 14. The tile positioned in a traveling direction corresponds to, for example, a tile positioned within a range of a predetermined angle to the left and right from a straight line indicating the traveling direction with the vehicle 3 as the center. The priority order of tiles positioned within this range may be, for example, order of smaller distances from a current position of the vehicle 3. Note that the output unit 204 preferably outputs reachability and planimetric feature information located in tiles having the same priority in order from ones that can be calculated more quickly.

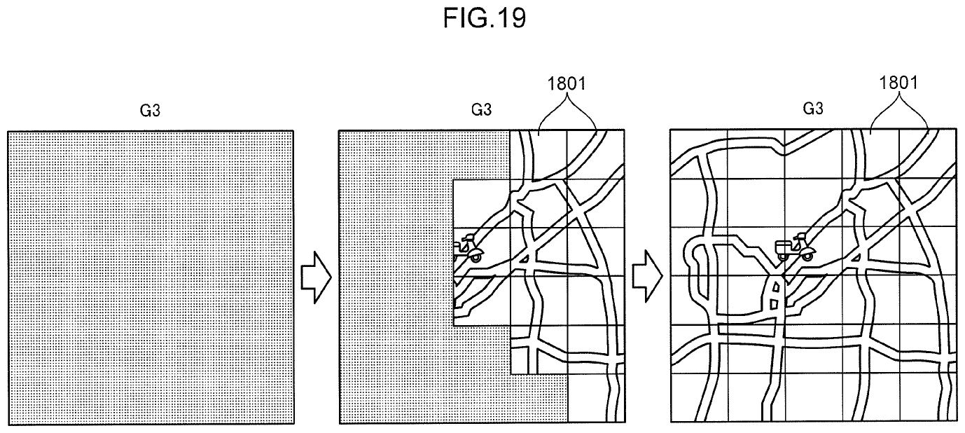

FIG. 19 is a diagram illustrating an example of a display screen G3 in the tenth modification of the present disclosure. From left to right, the superimposed map images 1801 are displayed in order from the superimposed map image 1801 of a tile located in the traveling direction of the vehicle 3.

In this manner, the user can preferentially recognize reachability of a planimetric feature in the traveling direction.

Note that the output unit 204 may output planimetric feature information and reachability in association with the above-described priority order.

(Eleventh Modification)

In an eleventh modification, the output unit 204 outputs reachability and planimetric feature information such that a tile closer to a current position of the vehicle 3 is more prioritized in display order. The output unit 204 calculates a distance to a current position of the vehicle 3 for all tiles requested from the display device 1, determines priority in the order of smaller distances, and preferentially outputs reachability and planimetric feature information located in a tile higher in priority. The display device 1 generates a superimposed map image in order of receiving of planimetric feature information and reachability, and displays the superimposed map image on the display unit 14. Note that the output unit 204 preferably outputs reachability and planimetric feature information located in tiles having the same priority in order from ones that can be calculated more quickly.

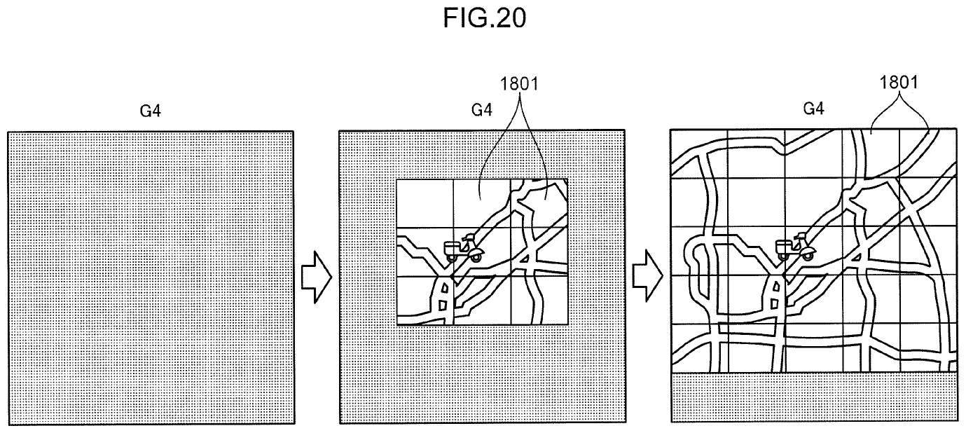

FIG. 20 is a diagram illustrating an example of a display screen G4 in the eleventh modification of the present disclosure. From left to right, the superimposed map images 1801 are displayed in order from the superimposed map image 1801 of a tile located closer to a current position of the vehicle 3.

In this manner, the user can recognize reachability preferentially from an earlier place to which the vehicle possibly moves.

Note that the output unit 204 may output planimetric feature information and reachability in association with the above-described priority order.

(Twelfth Modification)

In a twelfth modification, the output unit 204 outputs reachability and planimetric feature information such that a tile including a road as a planimetric feature is prioritized in display order. The output unit 204 sets reachability and planimetric feature information located in a tile including a road as a planimetric feature to be higher in priority order than reachability and planimetric feature information located in a tile not including a road as a planimetric feature among all tiles requested from the display device 1, and outputs reachability and planimetric feature information according to the priority order. The display device 1 generates a superimposed map image in order of receiving of planimetric feature information and reachability, and displays the superimposed map image on the display unit 14. Note that between tiles including a road, a tile including a main road is set to be higher in priority order than in a tile not including a main road, for example. The main road is, for example, a national road, a prefectural road, a toll road, or the like. Alternatively, between tiles including a road, a tile may be set to be higher in priority order for a road with a larger traffic volume or a road with a larger number of lanes, for example.

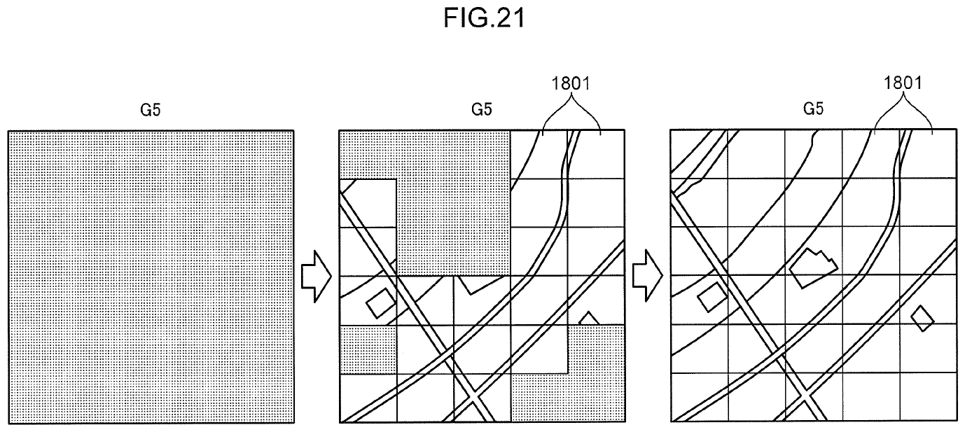

FIG. 21 is a diagram illustrating an example of a display screen G5 in the twelfth modification of the present disclosure. From left to right, the superimposed map images 1801 are displayed in order from the superimposed map image 1801 of a tile including a main road.

In this manner, the user can recognize a road and a route related to reachability before a place not related to reachability.

Note that the output unit 204 may output planimetric feature information and reachability in association with the above-described priority order.

### INDUSTRIAL APPLICABILITY

The present disclosure is useful in a technical field of automobiles because reachability can be quickly presented.

1. An information processing method in an information processing device that controls a display device that displays a map image divided into a plurality of tiles according to a zoom level, each tile being assigned with a tile ID, the information processing method comprising:
acquiring a plurality of requests corresponding to each of a plurality of tiles displayed on the display device, each of the requests including the tile ID, a current position of a vehicle, and remaining energy information of the vehicle; and
executing, in parallel, a plurality of pieces of response processing corresponding to the plurality of requests that are acquired, and
in each piece of the response processing,
extracting planimetric feature information indicating a planimetric feature to be displayed on each tile, the planimetric feature information corresponding to the tile ID included in a request, from a planimetric feature database in which the tile ID and the planimetric feature information are associated with each other;
calculating, based on the planimetric feature information that is extracted, a geographic feature amount between the current position and a feature indicated by the planimetric feature information that is extracted;
determining reachability by the vehicle to the planimetric feature based on the geographic feature amount that is calculated and the remaining energy information; and
outputting the reachability that is determined and the planimetric feature information that is extracted to the display device.

2. The information processing method according to claim 1, further comprising:
storing the planimetric feature information extracted from the planimetric feature database in a cache memory in association with the tile ID; and
in extraction of the planimetric feature information, extracting the planimetric feature information from the cache memory in a case where the planimetric feature information corresponding to the tile ID included in the request is stored in the cache memory.

3. The information processing method according to claim 1, wherein
the planimetric feature information includes geometry data indicating a topography of the planimetric feature, the information processing method further comprising:
extracting the geometry data corresponding to the zoom level from among pieces of the geometry data included in the planimetric feature information extracted by the planimetric feature database; and
in output to the display device, outputting the geometry data that is extracted by including the geometry data that is extracted in the planimetric feature information.

4. The information processing method according to claim 1, further comprising:
in calculation of the geographic feature amount, calculating the geographic feature amount with reference to a geographic feature amount database that stores the geographic feature amount between itself and a predetermined reachable planimetric feature for each of a plurality of planimetric features.

5. The information processing method according to claim 4, wherein
the plurality of planimetric features for which the geographic feature amount is stored in the geographic feature amount database are planimetric features allocated to each tile one by one at a maximum zoom level, and
the planimetric feature information stored in the planimetric feature database indicates a planimetric feature allocated to each tile one by one at the maximum zoom level.

6. The information processing method according to claim 1, wherein the geographic feature amount includes at least one of a distance between the current position and each planimetric feature, and an elevation difference between the current position and each planimetric feature.

7. The information processing method according to claim 1, wherein
the request includes additional information including at least one of vehicle information, user information, current time, and weather information, the information processing method further comprising:
in determination of the reachability, determining the reachability by the vehicle to each planimetric feature based on the additional information.

8. The information processing method according to claim 1, wherein the remaining energy information is a remaining power amount or remaining fuel of the vehicle.

9. The information processing method according to claim 1, wherein
the planimetric feature database includes a first table that stores the tile ID and a second table that stores the planimetric feature information, and
one piece of the planimetric feature information stored in the second table is associated with one or a plurality of tile IDs among the tile IDs stored in the first table.

10. The information processing method according to claim 1, further comprising:
in each piece of the response processing, extracting the planimetric feature information for, in addition to a first tile within a display range of the display device, a second tile positioned around the display range, calculating the geographic feature amount of the planimetric feature indicated by the planimetric feature information that is extracted, determining the reachability based on the geographic feature amount and the remaining energy information, and outputting the reachability that is determined and the planimetric feature information that is extracted.

11. The information processing method according to claim 10, wherein the second tile is a tile surrounding the display range, and is a tile located on an outer side by m (m is an integer of one or more) tiles from an outer periphery of the display range.

12. The information processing method according to claim 10, wherein
each request further includes a traveling direction of the vehicle, and
the second tile is a tile in the traveling direction of the vehicle.

13. The information processing method according to claim 10, wherein the second tile is a tile including a planimetric feature having the reachability that is substantially zero.

14. The information processing method according to claim 1, further comprising:
in the output, determining priority order of tiles such that a tile in which the planimetric feature having the reachability that is low is located is high in display order, and outputting preferentially the planimetric feature information and the reachability of a planimetric feature located in a tile that is high in the priority order.

15. The information processing method according to claim 1, wherein
each request further includes a traveling direction of the vehicle, the information processing method further comprising:
in the output, determining priority order of tiles such that a tile in the traveling direction is high in display order, and outputting preferentially the planimetric feature information and the reachability of a planimetric feature located in a tile that is high in the priority order.

16. The information processing method according to claim 1, further comprising:
in the output, determining priority order of tiles such that a tile close to the current position is high in display order, and outputting preferentially the planimetric feature information and the reachability of a planimetric feature located in a tile that is high in the priority order.

17. The information processing method according to claim 1, further comprising:
in the output, determining priority order of tiles such that a tile including a road as the planimetric feature is high in display order, and outputting preferentially the planimetric feature information and the reachability of a planimetric feature located in a tile that is high in the priority order.

18. An information processing device that controls a display device that displays a map image divided into a plurality of tiles according to a zoom level, each tile being assigned with a tile ID, the information processing device comprising:
an acquisition unit that acquires, from the display device, a plurality of requests corresponding to each of a plurality of tiles displayed on the display device, each of the requests including the tile ID, a current position of a vehicle, and remaining energy information of the vehicle; and
a parallel processing unit that executes, in parallel, a plurality of pieces of response processing corresponding to the plurality of requests that are acquired,
wherein in each piece of the response processing,
planimetric feature information indicating a planimetric feature to be displayed on each tile, the planimetric feature information corresponding to the tile ID included in a request, is extracted from a planimetric feature database in which the tile ID and the planimetric feature information are associated with each other,
based on the planimetric feature information that is extracted, a geographic feature amount between the current position and each feature is calculated,
reachability by the vehicle to the planimetric feature is determined based on the geographic feature amount that is calculated and the remaining energy information, and
the reachability that is determined and the planimetric feature information that is extracted are output to the display device.

19. A non-transitory computer-readable recording medium recording an information processing program that causes a computer to function as an information processing device that controls a display device that displays a map image divided into a plurality of tiles according to a zoom level, each tile being assigned with a tile ID, the information processing program causing a computer to function as:
an acquisition unit that acquires, from the display device, a plurality of requests corresponding to each of a plurality of tiles displayed on the display device, each of the requests including the tile ID, a current position of a vehicle, and remaining energy information of the vehicle; and
a parallel processing unit that executes, in parallel, a plurality of pieces of response processing corresponding to the plurality of requests that are acquired,
wherein in each piece of the response processing,
planimetric feature information indicating a planimetric feature to be displayed on each tile, the planimetric feature information corresponding to the tile ID included in a request, is extracted from a planimetric feature database in which the tile ID and the planimetric feature information are associated with each other,
based on the planimetric feature information that is extracted, a geographic feature amount between the current position and each feature is calculated,
reachability by the vehicle to the planimetric feature is determined based on the geographic feature amount that is calculated and the remaining energy information, and
the reachability that is determined and the planimetric feature information that is extracted are output to the display device.

20. A display device that displays a map image divided into a plurality of tiles according to a zoom level, each tile being assigned with a tile ID, the display device comprising:
a request output unit that outputs a plurality of requests corresponding to each of a plurality of tiles displayed by the display device to an information processing device;
a planimetric feature information acquisition unit that acquires, from the information processing device, planimetric feature information indicating a planimetric feature to be displayed on each tile extracted by response processing to the request, and reachability by a vehicle to a planimetric feature indicated by the planimetric feature information calculated by the response processing; and
a display control unit that superimposes and displays the reachability and a planimetric feature indicated by the planimetric feature information that is acquired on the map image.
